(19) United States
(12) Patent Application Publication
(10) Pub. No.: US 2020/0099076 A1
(43) Pub. Date: Mar. 26, 2020

(54) FUEL CELL SYSTEM INCLUDING SULFUR OXIDATION SUBSYSTEM AND METHOD OF OPERATING THE SAME

(71) Applicant: BLOOM ENERGY CORPORATION, Sunnyvale, CA (US)

(72) Inventors: David WEINGAERTNER, Sunnyvale, CA (US); Emad EL BATAWI, Sunnyvale, CA (US); Chockkalingam KARUPPAIAH, Cupertino, CA (US); Arne BALLANTINE, Palo Alto, CA (US)

(21) Appl. No.: 16/140,017

(22) Filed: Sep. 24, 2018

(51) Int. Cl. H01M 8/0662; H01M 8/04014; H01M 8/04701; H01M 8/04082; H01M 8/2475; H01M 8/2425

(52) U.S. Cl. CPC H01M 8/0675; H01M 8/04014; H01M 8/04708; H01M 2008/1293; H01M 8/0681; H01M 8/2475; H01M 8/2425; H01M 8/04201

(57) ABSTRACT

A fuel cell system includes a first fuel conduit configured to receive fuel from a fuel source, a reactor fluidly connected to the first fuel conduit and configured to selectively oxidize sulfur species in fuel received from the first fuel conduit, and fuel cells configured to generate power using fuel containing oxidized sulfur species received from the reactor.

### BACKGROUND

### Field

Aspects of the present disclosure relate to fuel cells systems including sulfur oxidation subsystems.

### Description of the Background

Fuel cells, such as solid oxide fuel cells (SOFC's), are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

The reliability of fuel cell systems, such as a solid oxide fuel cell (SOFC) system, depends on the presence and concentration of contaminants in the fuel stream. Contaminants, such as moisture, oxygen, siloxanes, and sulfur (including sulfur compounds), may degrade the fuel cell stack's performance and cause irreversible damage resulting in decrease efficiencies and costly replacement. Specifically, when using natural gas as a fuel, fuel cell systems require desulfurization. Passing fuel through desulfurizer sorbent beds is one way to remove sulfur and sulfur compounds from fuel prior to use in a fuel cell.

### SUMMARY

According to various embodiments, a fuel cell system comprises a first fuel conduit configured to receive fuel from a fuel source, a reactor fluidly connected to the first fuel conduit and configured to selectively oxidize sulfur species in fuel received from the first fuel conduit, and fuel cells configured to generate power using fuel containing oxidized sulfur species received from the reactor.

According to various embodiments, a method of operating a fuel cell system comprises oxidizing sulfur species included in a fuel inlet stream provided to the fuel cell system, and providing the fuel inlet stream including the oxidized sulfur species to fuel cells to generate power.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIGS. 1A and 1B are schematic views of a SOFC system including a sulfur oxidation subsystem, according to various embodiments of the present disclosure.

FIG. 2 is a schematic view of the SOFC system of FIG. 1A, including a modified sulfur oxidation subsystem, according to various embodiments of the present disclosure.

FIG. 3 is a schematic view of the SOFC system of FIG. 1A, including a modified sulfur oxidation subsystem, according to various embodiments of the present disclosure.

FIG. 4 is a schematic view of a reactor included in various sulfur oxidation subsystem, according to various embodiments of the present disclosure.

FIG. 5 is a schematic view of another reactor that may be included in various sulfur oxidation subsystem, according to various embodiments of the present disclosure.

FIG. 6A is a schematic view of another reactor that may be included in various sulfur oxidation subsystem, according to various embodiments of the present disclosure, and FIG. 6B is a schematic view of an electrochemical bed included in the reactor of FIG. 6A.

FIG. 7 is a schematic view of the SOFC system of FIG. 1A, including a modified sulfur oxidization subsystem, according to various embodiments of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It will also be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. In some embodiments, a value of “about X” may include values of +/−1% X. It will be further understood that the endpoints of each of the ranges are significant both in relation to the other endpoint, and independently of the other endpoint.

### Solid Oxide Fuel Cell (SOFC) Systems

SOFC systems are generally configured to operate most efficiently using natural gas. However, natural gas and other fuel sources may include contaminants, such as sulfur species. For example, natural gas may be contaminated with sulfur species such as, hydrogen sulfide (H₂S), t-butyl mercaptan (C₄H₁₀S), tetrahydrothiophene (C₄H₈S), or the like. Generally, prior to being supplied to a fuel cell stack, fuel is passed through one or more sorbent beds to prevent such contaminants from reaching and poisoning fuel cell catalysts, such as anode catalysts. The sorbent beds (e.g., absorbent and/or adsorbent beds) have a finite life and once the sorbent bed is exhausted, sulfur may pass through the sorbent bed without being adsorbed and reach the fuel cell stack, causing either transient or permanent damage. If sorbent beds are replaced prior to exhaustion, there may be underutilized portions of the sorbent bed increasing the cost of sorbent bed replacement.

The present inventors have discovered that some sulfur oxides, such as SO₂ and SO₃ may pass through the SOFC system without poisoning fuel cell catalysts. Accordingly, various subsystems are provided for oxidizing sulfur species into the above sulfur oxides.

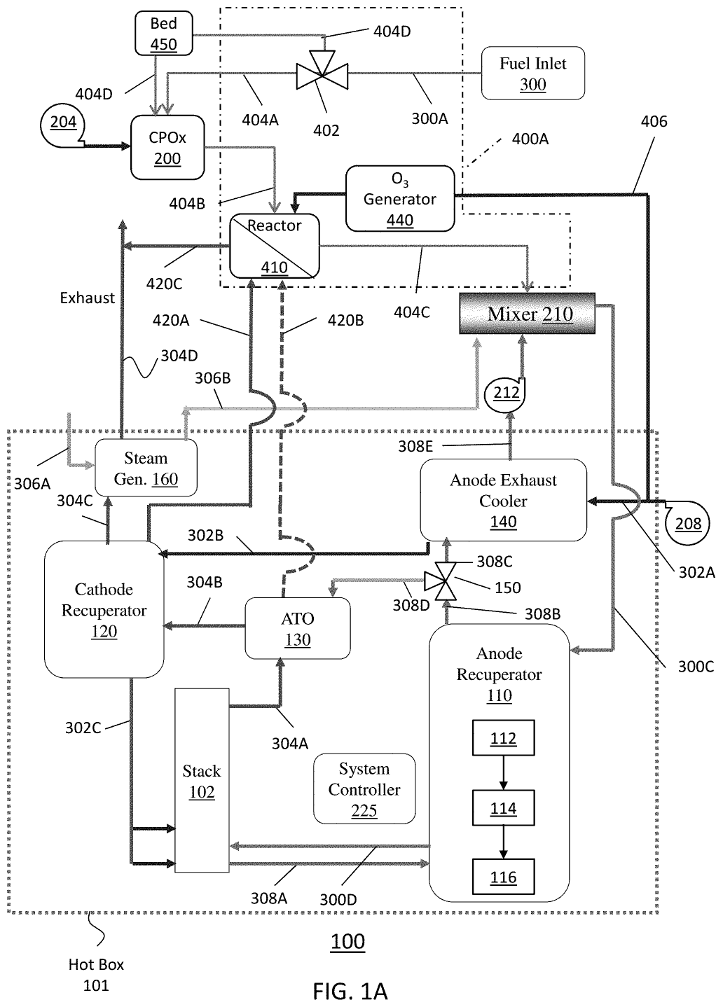

FIGS. 1A and 1B are schematic representations of a SOFC system 100, according to various embodiments of the present disclosure. Referring to FIG. 1A, the system 100 includes a hot box 101 and various components disposed therein or adjacent thereto.

The hot box 101 may contain fuel cell stacks 102, such as a solid oxide fuel cell stacks (where one solid oxide fuel cell of the stack contains a ceramic electrolyte, such as yttria stabilized zirconia (YSZ), scandia stabilized zirconia (SSZ), or ceria-ytterbia (SSZ), an anode electrode, such as a nickel-YSZ, Ni-SSZ, or nickel-samaria doped ceria cermet, and a cathode electrode, such as lanthanum strontium manganite (LSM)). The stacks 102 may be arranged over each other in a plurality of columns.

The hot box 101 may also contain an anode recuperator 110, a cathode recuperator 120, an anode tail gas oxidizer (ATO) 130, an anode exhaust cooler 140, a splitter 150, and a steam generator 160. The system 100 may also include a catalytic partial oxidation (CPOx) reformer 200, a mixer 210, a CPOx blower 204, a main air blower 208, and an anode recycle blower 212, which may be disposed outside of the hot box 101. However, the present disclosure is not limited to any particular location for each of the components with respect to the hot box 101.

The CPOx reactor 200 receives a fuel inlet stream from a fuel inlet 300 such as a natural gas fuel from a natural gas pipeline, through fuel conduit 300A. The CPOx blower 204 may provide air to the CPOx reactor 200. During a cold startup the fuel is partially oxidized in the CPOx reactor 200 by injection of air from the CPOx blower 204. The CPOx reactor 200 may include a glow plug to initiate this catalytic reaction. During this cold-start operational mode, the CPOx reactor 200 may be operated at a temperature ranging from about 600° C. to about 800° C., such as from about 650° C. to about 750° C., or about 700° C. The CPOx blower 204 generally operates during startup, and is usually not operated during steady-state system operation.

The fuel and/or air may be provided from the CPOx reactor 200 to fuel conduit 300C or to the mixer 210, through a fuel conduit 300B. In the mixer 210, the fuel (i.e., the fuel inlet steam) may be mixed with steam and/or anode exhaust provided by anode exhaust conduit 308E from the anode exhaust cooler 140. Fuel flows from the mixer 210 to the anode recuperator 110, through fuel conduit 300C. Fuel flows from the anode recuperator 110 to the stack 102 through fuel conduit 300D.

The main air blower 208 may be configured to provide an air inlet stream to the anode exhaust cooler 140 through air conduit 302A. Air flows from the anode exhaust cooler 140 to the cathode recuperator 120 through air conduit 302B. The air flows from the cathode recuperator 120 to the stack 102 through air conduit 302C.

Anode exhaust generated in the stack 102 is provided to the anode recuperator 110 through anode exhaust conduit 308A, in addition to CO, CO₂, H₂, and H₂O. The anode exhaust may contain unreacted fuel. As such, the anode exhaust may also be referred to herein as fuel exhaust. A first portion of the anode exhaust is provided from the anode recuperator 110 to a splitter 150 by anode exhaust conduit 308B. A second portion of the anode exhaust may be provided from the splitter 150 to the anode exhaust cooler 140 by anode exhaust conduit 308C, where heat from the anode exhaust is used to preheat the air inlet stream. Anode exhaust may be provided from the splitter 150 to the ATO 130 by anode exhaust conduit 308D. The first portion of the anode exhaust may be provided from the anode exhaust cooler 140 to mixer 210 by anode exhaust conduit 308E. The anode recycle blower 212 may be configured to move anode exhaust though anode exhaust conduit 308E, as discussed below.

Cathode exhaust generated in the stack 102 flows to the ATO 130 through exhaust conduit 304A. Cathode exhaust and/or ATO exhaust generated in the ATO 130 flows from the ATO 130 to the cathode recuperator 120 through exhaust conduit 304B, where heat from the anode exhaust is used to preheat the air inlet stream. ATO exhaust flows from the cathode recuperator 120 to the steam generator 160 through exhaust conduit 304C. Exhaust flows from the steam generator 160 and out of the hot box 101 through exhaust conduit 304D.

Water flows from a water source (not shown), such as a water tank or a water pipe, to the steam generator 160 through water conduit 306A. The steam generator 160 converts the water into steam using heat from the ATO exhaust provided by exhaust conduit 304C. Steam is provided from the steam generator 160 to the mixer 210 through water conduit 306B. Alternatively, if desired, the steam may be provided directly into the fuel inlet stream and/or the anode exhaust stream may be provided directly into the fuel inlet stream followed by humidification of the combined fuel streams. The mixer 210 is configured to mix the steam with anode exhaust and fuel. This fuel mixture may then be heated in the anode recuperator 110 by heat from the anode exhaust, before being provided to the stack 102.

The anode recuperator 110 may optionally include various catalysts. For example, the anode recuperator 110 may include an oxidation catalyst 112 configured to remove oxygen from the fuel, a hydrogenation catalyst 114 configured to combine unsaturated hydrocarbons, such as ethylene and propylene (alkenes), with available hydrogen in the fuel, resulting in saturated hydrocarbons, and a reforming catalyst 116 configured to partially reform the fuel before the fuel is delivered to the stack 102.

The system 100 may further include a system controller 225 configured to control various elements of the system 100. The controller 225 may include a central processing unit configured to execute stored instructions. For example, the controller 225 may be configured to control fuel and/or air flow through the system 100, by controlling the speed of the blower(s) 208, 212 and/or fuel flow rate from the fuel inlet 300, using a computer-controlled valve.

### Sulfur Oxidation Subsystems

The system 100 of the embodiment shown in FIG. 1A may also include a sulfur oxidation subsystem 400A configured to oxidize sulfur species in the fuel. In some embodiments, the subsystem 400A may be configured to partially oxidize sulfur species to form sulfur oxides, such as SO₂ and/or SO₃. For example, the subsystem 400A may be configured to oxidize sulfur species according to the following oxidation reactions:

H₂S+O₂→SO₂+H₂;

C₄H₁₀S+O₂→SO₂+C₄H₁₀; and

C₄H₈S+O₂→SO₂+C₄H₈.

The subsystem 400A may include a valve 402, fuel conduits 404A, 404B, 404C, 404D, and a reactor 410. Fuel conduit 404A may fluidly connect the valve 402 to the CPOx reactor 200. The valve 402 may be a three-way, computer-controlled valve or two two-way valves. Fuel conduit 404B may fluidly connect the CPOx reactor 200 to the reactor 410, and fuel conduit 404C may fluidly connect the reactor 410 to the mixer 210. The subsystem 400A may include an optional fuel conduit 404D that provides an alternate fluid connection between the valve 402 to the CPOx reactor 200. An optional low temperature adsorption bed 450 may be disposed on fuel conduit 404D. The bed is located upstream, of the CPOx reactor 200 such that the bed 450 is not exposed to the CPOx reactor 200 operating temperature of 600 degrees Celsius and above.

During startup, the controller 225 may be configured to operate the valve 402, such that fuel is directed into fuel conduit 404D and sulfur species from the fuel are adsorbed by adsorption bed 450, until the reactor 410 reaches an operating temperature ranging from about 400° C. to about 700° C. (e.g., after the CPOx reactor 200 and then the fuel cell stack 102 reach their respective operating temperature). Once the reactor 410 has reached the operating temperature, such as during steady-state operations, the controller 225 may be configured to operate the valve 402, such that fuel is directed into the CPOx reactor 200, via fuel conduit 404A, bypassing the bed 450. During an equipment failure, such as during reactor 410 failure, reactor 410 catalyst exhaustion, or the like, the valve 402 may be adjusted such that fuel flows through the low temperature adsorption bed 450 via conduit 404D, to provide desulfurization for a relatively short duration while the reactor 410 is repaired, replaced, or regenerated.

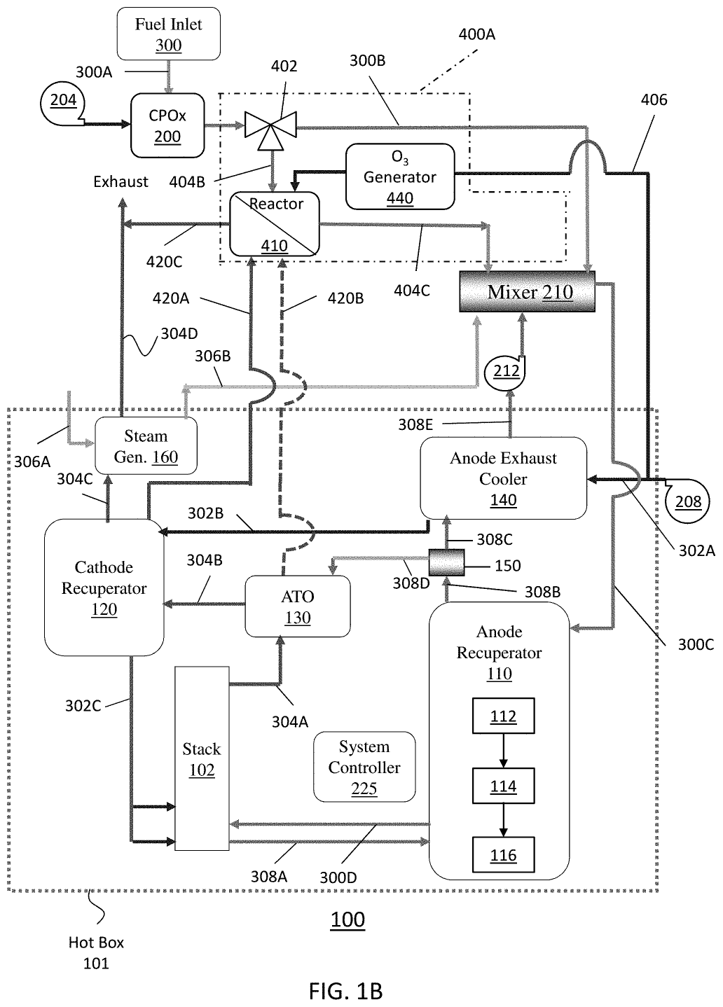

In an alternative embodiment illustrated in FIG. 1B, the bed 450 and conduits 404A and 404D are omitted and the above described valve 402 is located downstream of the CPOx reactor 200. The controller 225 may be configured to operate the valve 402, such that fuel is directed into the reactor 410 through the fuel conduit 404A, once the stack 102 reaches a temperature ranging from about 500-600° C. Until then, the subsystem 400A may be bypassed by operating the valve 402 to provide the fuel into a bypass conduit 300B during startup, until the fuel cell stack 102 reaches such a temperature, since it is believed that at lower temperatures sulfur species do not react with, and thereby poison, fuel cell anode catalysts, such as nickel cermets in the fuel cell stack 102. Thus, in this alternative embodiment, the fuel flows from the CPOx reactor 200 into the mixer 210 through the valve 402 and the bypass conduit 300B during system start-up. Furthermore, while the bypass conduit 300B is not shown in other embodiment systems illustrated in FIGS. 2, 3 and 7, it should be understood that the bypass conduit 300B may be used instead of the bed 450 in the other embodiment systems illustrated in FIGS. 2, 3 and 7.

In some embodiments, O₂ (e.g., air) may be injected into the fuel in order to provide O₂ for the oxidation of the sulfur species. It is believed that the reactions between O₂ and the sulfur species are energetically more favorable than reactions between the O₂ and the higher hydrocarbons included in the fuel. Accordingly, the air may be injected into the fuel upstream of the mixer 210, before the fuel is mixed with anode exhaust in the mixer 210, since the anode exhaust may include more reactive H₂ and CO species. For example, controller 225 may be configured to operate the CPOx blower 204, in order to inject an oxygen-containing gas, such as a small amount of air, into the fuel. In other embodiments, the air may be provided by the system blower 208, via a bleed conduit 406 connected to the fuel conduit 400A or the reactor 410, upstream of the mixer 210. [

The amount of air injected may be determined according to an amount of sulfur species included in the fuel. For example, based on stoichiometry, only about 15 to about 40 ppm, such as about 20-25 ppm of air may be sufficient to oxidize the sulfur species. However, a larger amount of air may be injected to insure that substantially all of the sulfur species are oxidized. For example, an amount of air ranging from about 0.5 to about 2 vol %, such as about 1 vol % may be injected into the fuel, based on the total volume of the fuel.

In some embodiments, the reactor 410 may include a sulfur oxidation catalyst configured to selectively catalyze the oxidization of the sulfur species. Any suitable sulfur oxidation catalyst may be used, such as a noble metal containing catalyst. For example, a diesel fuel type catalyst containing one or more noble metals, such as Pt, Pd and/or Rh, and a ceramic substrate, such as an alumina substrate, may be used. The operating temperature of the reactor may vary, according to the type of sulfur oxidation catalyst included therein. For example, the operating temperature may range from about 300° C. to about 800° C.

The fuel and/or air may be heated to the operating temperature of the sulfur oxidation catalyst included in the reactor 410. In particular, exemplary sulfur oxidation subsystems disclosed therein may be configured to heat the fuel and/or air to different temperatures using heat extracted from different parts of the system 100. The fuel inlet stream containing oxidized sulfur species (e.g., SO₂/SO₃) is then provided from the reactor 410 into the mixer 210, via conduit 404B.

For example, the subsystem 400A may include a cathode exhaust conduit 420A fluidly connecting the cathode recuperator 120 to the reactor 410. Cathode exhaust cooled by the cathode recuperator 120 may be provided to the reactor 410, by the cathode exhaust conduit 420A. The cooled cathode exhaust may be used to heat the fuel and/or air up to about 300° C., which may be sufficient for certain sulfur oxidation catalysts.

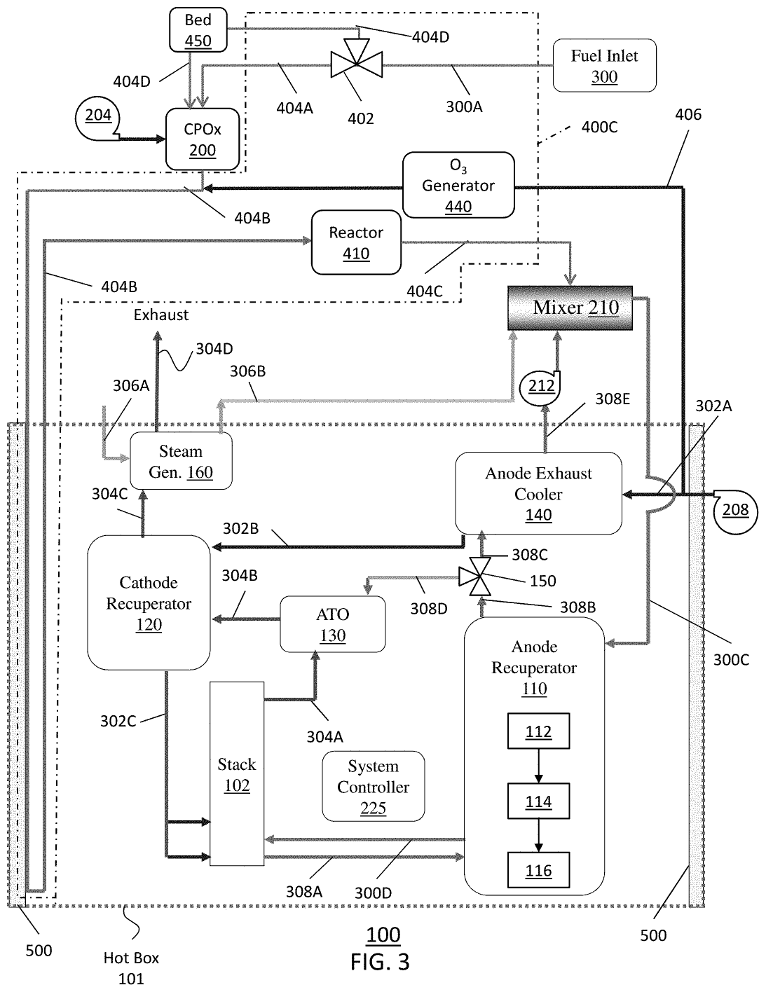

In other embodiments, the subsystem 400A may include a cathode exhaust conduit 420B fluidly connecting the ATO 130 to the reactor 410 to provide a part of the ATO exhaust to heat the fuel inlet stream in the reactor 410, while providing a remainder of the ATO exhaust to the cathode recuperator 120. Since the ATO exhaust in conduit 420B is not cooled by the cathode recuperator 120, the ATO exhaust may heat the fuel and/or air in the reactor 410 to a higher temperature, such as a temperature ranging from about 400° C. to about 700° C. The cathode or ATO exhaust exits the reactor 410 via outlet conduit 420C into exhaust conduit 304D. Accordingly, the cathode and/or ATO exhaust does not mix with fuel provided to the reactor 410 because the reactor includes a heat exchanger (shown schematically by the diagonal line in the figure and illustrated in more detail in FIG. 4) in which the exhaust is physically separated from the fuel.

In some embodiments, the subsystem 400A may optionally include an ozone (O₃) generator 440 configured to generate ozone from air supplied to the reactor 410 from the main air blower 208 and/or CPOX blower 204. The ozone may operate to increase the oxidation rate in the reactor 410.

In various embodiments, the reactor 410 may be configured to oxidize sulfur species without heating the air and/or fuel, such as when the reactor 410 includes adsorption beds configured to perform electrochemical oxidation of sulfur species, as discussed below. Accordingly, cathode exhaust conduits 420A, 420B may be omitted from the subsystem 400A when the reactor 410 has such a configuration.

FIG. 2 is a schematic representation of the SOFC system 100, including a modified sulfur oxidation subsystem 400B, according to various embodiments of the present disclosure. Referring to FIG. 2, the subsystem 400B may include an anode exhaust conduit 422A that fluidly connects the reactor 410 to anode exhaust conduit 308E, and an anode exhaust conduit 422B that fluidly connects the reactor 410 to the mixer 210. Accordingly, cooled anode exhaust from the anode exhaust cooler 140 may be provided to the reactor 410, via anode exhaust conduit 422A, to heat the fuel and/or air up to about 300° C., before being provided to the mixer 210, via anode exhaust conduit 422B. The anode exhaust exits the reactor 410 via outlet conduit 420C into exhaust conduit 304D. Accordingly, the anode exhaust does not mix with fuel provided to the reactor 410 because the reactor includes a heat exchanger (shown schematically by the diagonal line in the figure and illustrated in more detail in FIG. 4) in which the exhaust is physically separated from the fuel.

In alternative embodiments, the subsystem 400B may include an anode exhaust conduit 422C fluidly connecting the splitter 150, conduit 308C, and/or conduit 308D, to the reactor 410, and anode exhaust conduit 422A may be omitted. Since the anode exhaust is not cooled by the anode exhaust cooler 140, the anode exhaust may heat the fuel and/or air in the reactor 410 to a higher temperature, such as a temperature ranging from about 400 to about 700° C. In further alternative embodiments, anode exhaust conduit 422C may be directly connected to anode exhaust conduit 308A. As such, even higher temperature anode exhaust emitted from the stack 102 may be provided to the reactor 410, to heat the fuel and/or air to an even higher temperature. The anode exhaust exits the reactor 410 via outlet conduit 420C into exhaust conduit 304D. Accordingly, the anode exhaust does not mix with fuel provided to the reactor 410 because the reactor includes a heat exchanger (shown schematically by the diagonal line in the figure and illustrated in more detail in FIG. 4) in which the exhaust is physically separated from the fuel.

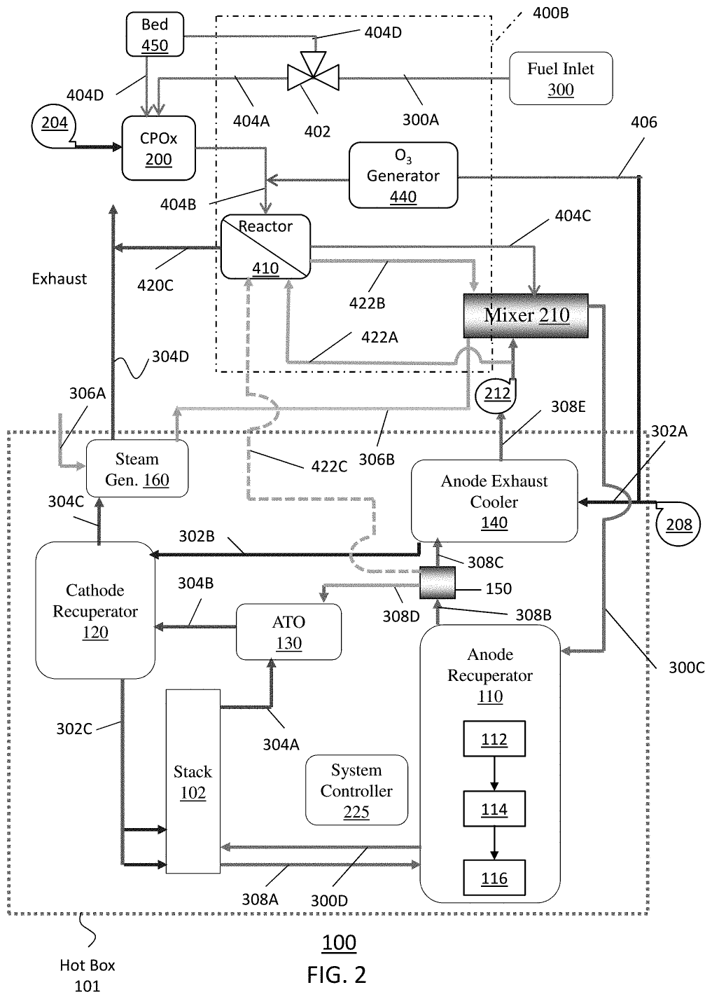

FIG. 3 is a schematic representation of the SOFC system 100, including a modified sulfur oxidation subsystem 400C, according to various embodiments of the present disclosure. Referring to FIG. 3, fuel conduit 404B may be disposed inside the hot box 101. For example, fuel conduit 404B may be disposed within free-flow insulation 500 covering the inner surface of sidewalls of the hot box 101. In some embodiments, fuel conduit 404B may be wrapped around the inside of the hot box 101 one or more times (e.g. in a spiral pattern). Accordingly, air and/or fuel in fuel conduit 404B may be heated to temperatures of up to about 700° C. or more, without providing ATO, anode, or cathode exhaust to the reactor 410.

In other embodiments, the reactor 410 may be disposed inside of the insulation 500 in the hot box 101. Accordingly, the reactor 410 may be heated without providing anode or cathode exhaust to the reactor 410.

FIG. 4 is a schematic representation of the reactor 410 of any of the above subsystems 400A, 400B, 400C, according to various embodiments of the present disclosure. Referring to FIG. 4, the reactor 410 may include an oxidation chamber 412 in which a sulfur oxidation catalyst 414 is disposed. For example, the sulfur oxidation catalyst 414 may be coated on the internal surface of the oxidation chamber 412. In other embodiments, the sulfur oxidation catalysts 414 may be disposed on a porous support or a matrix disposed in the oxidation chamber 412.

The oxidation chamber 412 may be in the form of a conduit or pipe configured to receive a mixture of fuel and air. For example, the oxidation chamber 412 may have a serpentine configuration, to increase surface contact between the sulfur oxidation catalyst 414 and the mixture.

In some embodiments, the reactor 410 may optionally include a heat exchanger 416 and/or a trim heater 418. For example, the trim heater 418 may be provided in embodiments where an operating temperature of the sulfur oxidation catalyst 414 is higher than a temperature that can be achieved using only heat harvested from the system 100.

The heat exchanger 416 may be configured to convectively, conductively, and/or radiatively transfer heat from the ATO, anode, or cathode exhaust to the fuel and/or air. The trim heater 418 may be configured to further heat the fuel and/or air, before the fuel and air are provided to the oxidation chamber. The trim heater 418 may include an electric heating element driven by power output from the stack 102. In an alternative embodiment, the trim heater 418 may include a combustor configured to provide heat by combusting the fuel and/or the anode exhaust.

The oxidation chamber 412, heat exchanger 416, and trim heater 418 may be separate elements disposed on fuel conduits 404B and/or 404C, or may be combined into a single integrated structure.

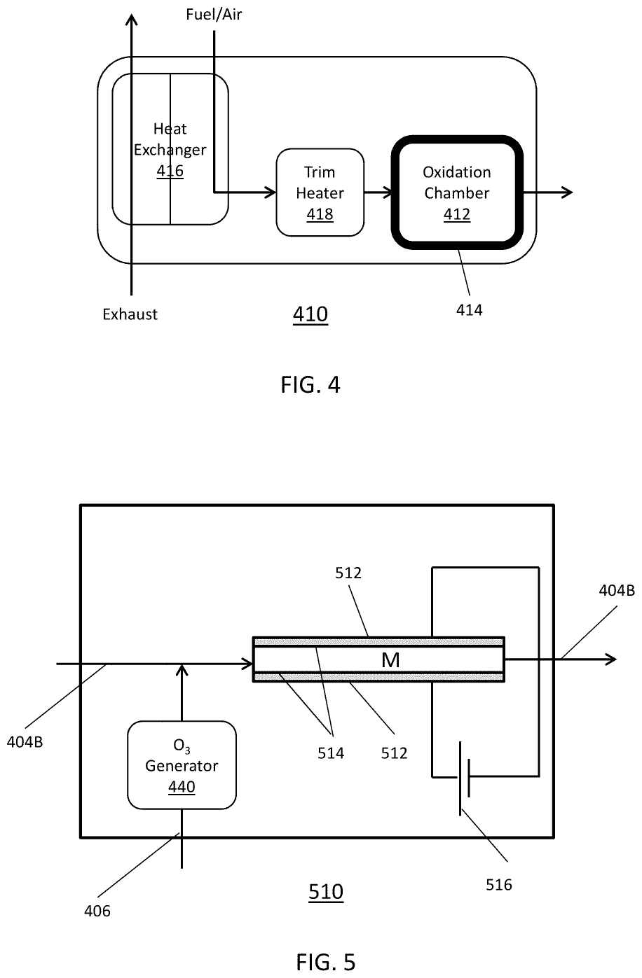

FIG. 5 is a schematic representation of one embodiment of a reactor 510 that may be included in place of the reactor 410 in any of the above subsystems 400A, 400B, 400C, according to various embodiments of the present disclosure. Referring to FIG. 5, the reactor 510 may be configured to apply a frequency that selectively excites R—S—H bonds in the sulfur species. For example, the reactor 510 may include opposing conductive plates 512 separated by a narrow gap configured to receive a mixture of fuel and air M. The conductive plates 512 may be connected to a voltage source 516, such as a DC voltage source. The reactor 510 may include a sulfur oxidation catalyst 514 coated on opposing surfaces of the plates 512.

In operation, the voltage source may apply a high voltage potential between the plates 512. The voltage potential may be tuned to selectively excite R—S—H bonds in the sulfur species included in the mixture M. Accordingly, the oxidation of the sulfur species may be enhanced by the voltage potential. In various embodiments, an ozone generator 440 may be provided to enhance the reactivity of air provided to conduit 404B via conduit 406.

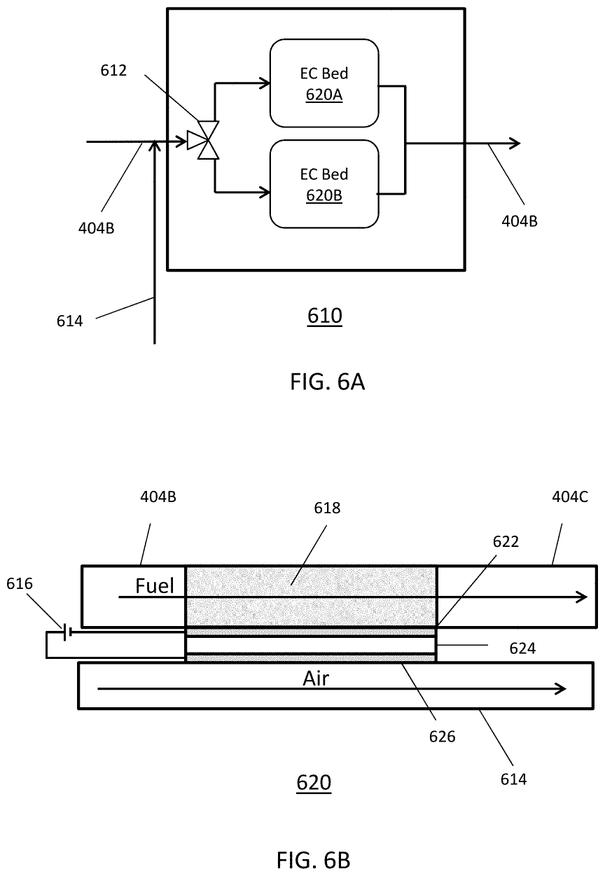

FIG. 6A is a schematic representation of one embodiment of a reactor 610 that may be included in place of the reactor 410 in any of the above subsystems 400A, 400B, 400C, according to various embodiments of the present disclosure. FIG. 6B is a schematic view of one electrochemical bed 620 included in the reactor 610.

Referring to FIG. 6A, the reactor 610 may include at least one computer-controlled valve 612 fluidly connected to fuel conduit 404B. The reactor 610 may also include first and second electrochemical beds 620A, 620B, which may be fluidly connected in parallel to the valve 612. The electrochemical beds 620A, 620B may also be connected to an oxidant conduit 614, which may be configured to provide air from the CPOx blower 204 or the main air blower 208 (see FIG. 1A), for example.

The valve may be a multi-way valve, such as a three-way or four-way valve. In other embodiments, the valve may include multiple two-way and/or three-way valves. In operation, the valve 612 may be adjusted to direct fuel into the first electrochemical bed 620A. As the fuel flows through the first electrochemical bed 620A, sulfur species may be adsorbed onto a surface of the electrochemical bed 620A. The adsorption may be accomplished without any electrochemical pumping. As such, the oxidation of hydrocarbons in the fuel would be prevented.

Before the adsorption limit of the first electrochemical bed 620A is reached, the valve 612 may be adjusted to direct fuel into the second electrochemical beds 620B. A voltage potential may be applied to the first electrochemical bed 620A to electrochemically oxidize the adsorbed sulfur species. In some embodiments, the valve 612 may be adjusted to supply an oxidative species, such as air or ozone from conduit 614, to the first electrochemical bed 620A. If electrochemical oxidation is slower than sulfur adsorption, additional electrochemical beds may be included, such that one electrochemical bed is used for adsorption while the other two electrochemical beds are used for electrochemical oxidation. After completion of electrochemical oxidation, the position of the valve 612 may be reversed and electrochemical oxidation of the second bed 620B takes place, while fuel flows through the first bed 620A.

Referring to FIG. 6B, an electrochemical bed 620 may include a sulfur adsorbent 618 and an oxygen ion conductive electrolyte 624 disposed between an anode 622 and a cathode 626. The cathode 626 may be exposed to air and/or ozone from conduit 614, and the anode 622 may be exposed to fuel flowing through the sulfur adsorbent 618. Suitable electrolyte materials may be found in Skinner et al., Oxygen Ion Conductors, Materials Today, pgs. 30-37, (March, 2003), which is incorporated herein by reference. For example, suitable electrolyte materials include zirconia-scandia, ceria-gadolinia, yttria-stabilized zirconia, lanthanum strontium gallium magnesium oxide (LSGM), lanthanum germanium oxide, lanthanum silicon oxide, or the like. The anode 622 and cathode 626 may be connected to a voltage source 616 (e.g., a battery), such that the electrochemical bed may be configured to electrochemically pump oxygen anions from conduit 614 and cathode 626 towards the surfaces of the anode 622. While the electrochemical bed 620 is shown to be rectangular, in some embodiments, the electrochemical bed 620 may be cylindrical

According to various embodiments of the present disclosure, elements of the subsystems 400A-400C may be used together in various combinations. For example, one or more of the reactors 410, 510, 610 may be used together.

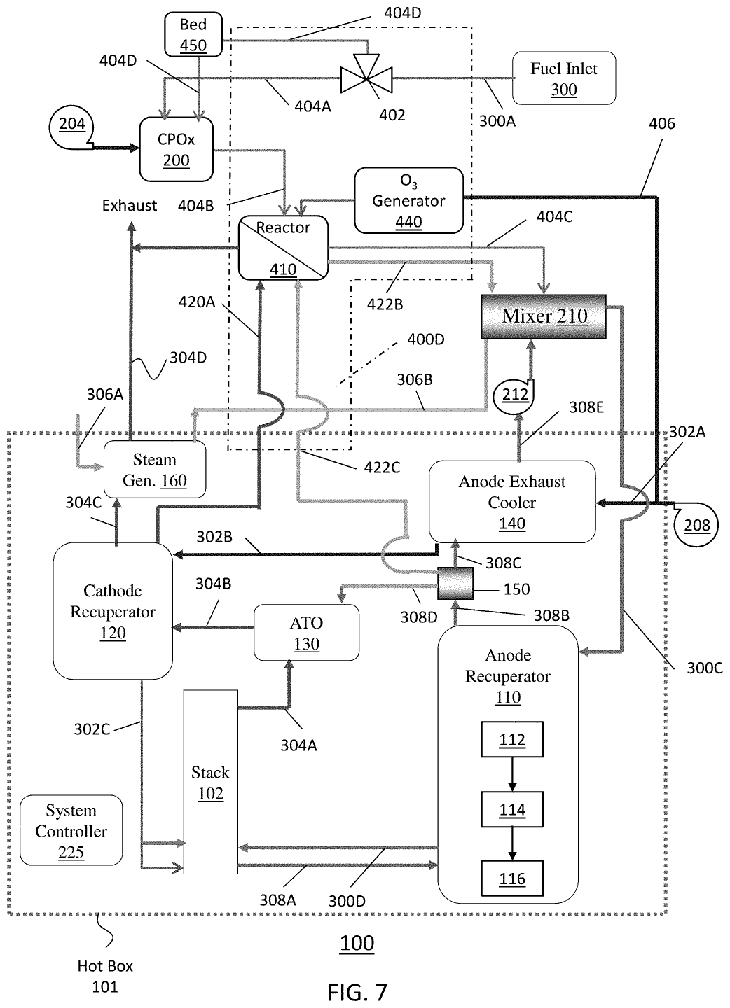

FIG. 7 is a schematic view of the SOFC system 100, including a sulfur oxidization subsystem 400D that includes elements of both subsystems 400A and 400B. Referring to FIG. 7, the subsystem 400D includes cathode exhaust conduit 420A, and anode exhaust conduits 422B, 422C. The fuel provided to the reactor 410 may be first heated with the cathode exhaust provided by cathode exhaust conduit 420A, and may then be heated with the relatively higher temperature anode exhaust provided by anode exhaust conduit 422C. The heated fuel may then be heated by a trim heater included in the reactor 410, if necessary, up to a temperature ranging from about 400° C. to about 700° C., or higher.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

What is claimed is:

1. A fuel cell system comprising:
a first fuel conduit configured to receive fuel from a fuel source;
a reactor fluidly connected to the first fuel conduit and configured to selectively oxidize sulfur species in fuel received from the first fuel conduit; and
fuel cells configured to generate power using fuel containing oxidized sulfur species received from the reactor.

2. The system of claim 1, further comprising a blower configured to inject air into fuel provided to the reactor, wherein:
the reactor comprises a catalyst configured to selectively catalyze an oxidation reaction between the injected air and the sulfur species; and
the reactor is configured to heat fuel received from the fuel conduit using at least one exhaust stream from the fuel cells.

3. The system of claim 2, wherein the reactor comprises a heat exchanger configured to heat to the fuel received from the fuel conduit using at least one exhaust stream from the fuel cells which does not mix with the fuel in the heat exchanger.

4. The system of claim 3, wherein the reactor further comprises a trim heater configured to increase the temperature of fuel heated by the heat exchanger.

5. The system of claim 3, further comprising:
a cathode recuperator heat exchanger configured to heat air provided to the fuel cells using cathode exhaust emitted from the fuel cells; and
a cathode exhaust conduit configured to provide the cathode exhaust from the cathode recuperator to the reactor to heat the fuel.

6. The system of claim 3, further comprising:
an anode tail gas oxidizer (ATO) configured to oxidize fuel exhaust from the fuel cells using cathode exhaust emitted from the fuel cells; and
an ATO exhaust conduit configured to provide ATO exhaust from the ATO to the reactor to heat the fuel.

7. The system of claim 3, further comprising:
an anode recuperator configured to heat fuel provided to the fuel cells using anode exhaust emitted from the fuel cells; and
an anode exhaust conduit configured to provide the anode exhaust from the anode recuperator to the reactor.

8. The system of claim 1, further comprising:
a blower configured to inject air into fuel provided to the reactor; and
an ozone generator configured to convert some or all of the oxygen in the air into ozone prior to the injection of the air into the fuel.

9. The system of claim 1, wherein the fuel provided to the reactor by the fuel conduit does not first pass through a sorbent bed configured to adsorb sulfur species from the fuel.

10. The system of claim 1, wherein the reactor comprises:
opposing first and second plates; and
a voltage source configured to apply a voltage potential between the first and second plates,
wherein the reactor is configured to oxidize sulfur species in fuel flowing between the first and second plates.

11. The system of claim 1, wherein the reactor comprises first and second electrochemical beds configured to adsorb sulfur species in a first mode from the fuel passing through the reactor and to actively oxidize the adsorbed sulfur species in a second mode.

12. The system of claim 11, wherein:
the reactor further comprises a valve fluidly connected to the first and second beds, the valve having a first position where the valve directs fuel into the first bed and not the second bed, and a second position where the valve directs fuel into the second bed and not the first bed; and
in the second mode, the first and second beds are configured to electrochemically pump oxygen anions towards the adsorbed sulfur species.

13. The system of claim 12, wherein the valve comprises a three-way valve or the valve comprises multiple two-way valves.

14. The system of claim 1, wherein:
the fuel cells comprise solid oxide fuel cells disposed in a stack;
the system comprises a hot box in which the stack is disposed; and
the first fuel line is disposed inside the hotbox, such that heat from the hot box is transferred to fuel in the first fuel line.

15. The system of claim 14, wherein the first fuel line is disposed within insulation disposed inside the hot box.

16. The system of claim 1, further comprising:
a second fuel line configured to bypass the reactor;
a valve configured to control fuel flow through the first and second fuel lines; and
a controller configured to control the valve, such that fuel flows through the second fuel line and bypasses the first fuel line when a temperature of the fuel cell stack is less than about 600° C.

17. The system of claim 1, wherein:
the fuel cells comprise solid oxide fuel cells disposed in a stack;
the reactor is configured to oxidize the sulfur species into SO₂, SO₃, or a combination thereof; and
the system is configured to provide fuel containing the SO₂, SO₃, or a combination thereof to the stack.

18. A method of operation a fuel cell system, comprising:
oxidizing sulfur species included in a fuel inlet stream provided to the fuel cell system; and
providing the fuel inlet stream including the oxidized sulfur species to fuel cells to generate power.

19. The method of claim 18, wherein:
the fuel comprises natural gas;
the sulfur species comprise H₂S, C₄H₁₀S, C₄H₈S, C2H6S, or any combination thereof;
the oxidized sulfur species comprise SO₂, SO₃, or a combination thereof; and
oxidizing the sulfur species comprises using a reactor comprising a sulfur oxidization catalyst.

20. The method of claim 19, further comprising providing air into the reactor and heating the reactor using at least one exhaust stream from the fuel cells.
